(19) United States
(12) Patent Application Publication
(10) Pub. No.: US 2016/0225524 A1
(43) Pub. Date: Aug. 4, 2016

(54) METHOD OF MANUFACTURING MULTILAYER CERAMIC ELECTRONIC COMPONENT

(71) Applicant: SAMSUNG ELECTRO-MECHANICS CO., LTD., Suwon-Si (KR)

(72) Inventors: Jin Kyung JOO, Suwon-Si, (KR); Byoung Hwa LEE, Suwon-Si (KR); Tae Ho KIM, Suwon-Si (KR); Doo Young KIM, Suwon-Si (KR); Taek Jung LEE, Suwon-Si (KR); Sin Il GU, Suwon-Si (KR)

(21) Appl. No.: 14/981,650

(22) Filed: Dec. 28, 2015

(30) Foreign Application Priority Data
Jan. 30, 2015 (KR) 10-2015-0015264

(51) Int. Cl. H01G 4/012; H01G 4/12

(52) U.S. Cl. CPC H01G 4/012; H01G 4/12

(57) ABSTRACT

A method of manufacturing a multilayer ceramic electronic component includes preparing a multilayer structure in which dielectric layers containing an alumina base material and internal electrode layers containing nickel are alternately stacked, plasticizing the multilayer structure by heating to a temperature of 500 to 900° C. at a first heating rate under a first reducing atmosphere at a first hydrogen concentration, sintering the multilayer structure by heating to a temperature of 1,250° C. to 1,400° C. at a second heating rate greater than the first heating rate under a second reducing atmosphere at a second hydrogen concentration higher than the first hydrogen concentration, and then maintaining the temperature of 1,250° C. to 1,400° C., and annealing the multilayer structure by cooling the multilayer structure to room temperature at a first cooling rate.

### CROSS-REFERENCE TO RELATED APPLICATION

This application claims the benefit of priority to Korean Patent Application No. 10-2015-0015264, filed on Jan. 30, 2015 with the Korean Intellectual Property Office, the entirety of which is incorporated herein by reference.

### BACKGROUND

The present disclosure relates to a method of manufacturing a multilayer ceramic electronic component, and more particularly, to a method of manufacturing a multilayer ceramic electronic component using a medium temperature co-sintering process.

Recently, miniaturization and thinning of information technology (IT) devices such as various communications devices or display devices has accelerated. Therefore, research into miniaturization, thinning, and high capacitance of various electronic components such as transformers, inductors, capacitors, transistors and the like employed in IT devices has been continuously conducted.

In particular, there is currently high demand for increased miniaturization, thinning, and high capacitance for multilayer ceramic capacitors (MLCCs). An important factor to be considered in the development of high capacitance multilayer ceramic capacitors is securing high reliability in accordance with applied voltage, along with whether capacitance may be implemented.

Generally, the reliability of a multilayer ceramic capacitor is determined by an evaluation of its heat insulation resistance properties and humidity insulation resistance properties.

The heat insulation resistance properties are affected by materials used (e.g., a dielectric forming a capacitor, deterioration properties of an internal electrode, and/or microstructural defects, etc.).

Meanwhile, the humidity insulation resistance property is determined based on structural aspects, such as structural defects including pores or delamination occurring in layers during a process of compressing or cutting layers, an uncoated area of an internal electrode generated after firing or sintering, or cracks easily occurring between layers, and pores in an external electrode.

### SUMMARY

An aspect of the present disclosure provides a method of manufacturing a multilayer ceramic electronic component including a multilayer structure having internal electrode layers containing low-cost nickel while having improved strength by a medium temperature co-sintered ceramic process.

According to an aspect of the present disclosure, a method of manufacturing a multilayer ceramic electronic component includes preparing a multilayer structure in which dielectric layers containing an alumina base material and internal electrode layers containing nickel are alternately stacked, plasticizing the multilayer structure by heating the multilayer structure to a temperature of 500° C. to 900° C. at a first heating rate under a reducing atmosphere at a first hydrogen concentration, sintering the multilayer structure by heating the multilayer structure to a temperature of 1,250° C. to 1,400° C. at a second heating rate greater than the first heating rate under a reducing atmosphere at a second hydrogen concentration higher than the first hydrogen concentration, and then maintaining the temperature of 1,250° C. to 1,400° C., and annealing the multilayer structure by cooling the multilayer structure to room temperature at a first cooling rate.

The dielectric layer may include 4 wt % to 15 wt % of a sintering aid relative to the alumina base material. The alumina base material may be fine particles having an average particle diameter of 500 nm or less.

The internal electrode layer may include 2 wt % to 15 wt % of a ceramic material relative to the nickel.

The first heating rate may be in a range of 1.5° C./min to 3° C./min.

The plasticizing may further include maintaining the temperature of 500° C. to 900° C., after heating the multilayer structure to the temperature of 500° C. to 900° C.

The second heating rate may be in a range of 5° C./min to 60° C./min.

The first hydrogen concentration and the second hydrogen concentration may be in a range of 0.05% to 3.0%.

The sintering may be carried out for 1 hour to 4 hours.

This method of manufacturing a multilayer ceramic electronic component may further include controlling the reducing atmosphere to be at a third hydrogen concentration different from the first hydrogen concentration and the second hydrogen concentration during the sintering.

The first cooling rate may be in a range of 1° C./min to 10° C./min.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a graph illustrating a method of manufacturing a multilayer ceramic electronic component according to an exemplary embodiment in the present disclosure;

FIG. 2 is a graph illustrating equilibrium oxygen partial pressure of metals used as an internal electrode layer of a multilayer ceramic electronic component; and

FIGS. 3A and 3B are photographs showing a part of a multilayer ceramic electronic component manufactured according to an exemplary embodiment in the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

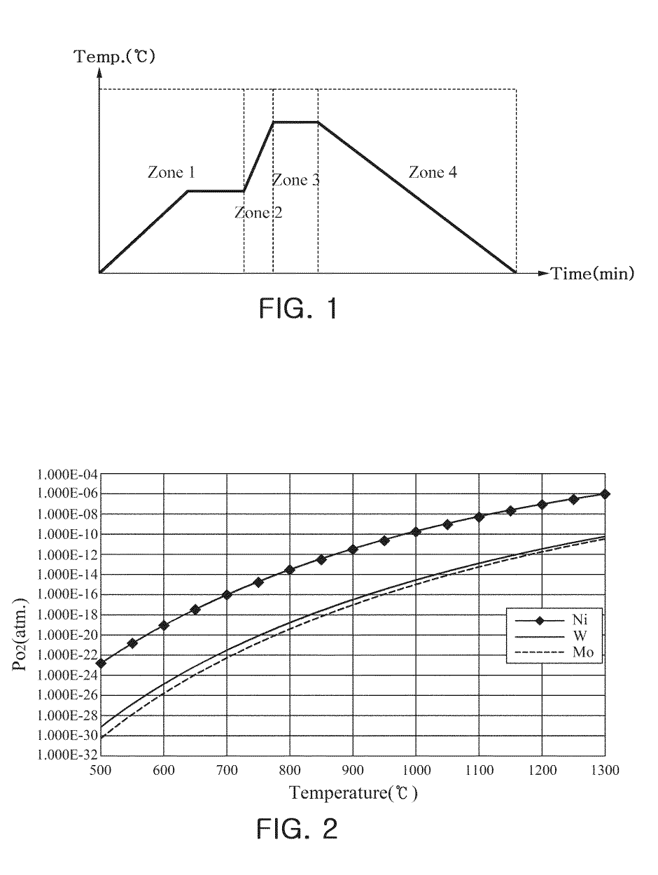

FIG. 1 is a graph illustrating a method of manufacturing a multilayer ceramic electronic component according to an exemplary embodiment.

Referring to FIG. 1, the multilayer ceramic electronic component includes a multilayer structure in which alumina (Al₂O₃)-based dielectric layers and internal electrode layers containing nickel (Ni) are alternately stacked. A method of manufacturing the multilayer ceramic electronic component including the multilayer structure will be described.

The multilayer ceramic electronic component, according to an exemplary embodiment, will be described using a multilayer ceramic capacitor as an example, but is not limited thereto. The multilayer ceramic electronic component may perform a function of other electronic components such as an inductor, a thermistor, and others by forming different structures of internal electrode layers.

First, the multilayer structure in which the dielectric layers containing an alumina base material and the internal electrode layers containing nickel are alternately stacked is prepared. The alumina base material may be fine particles having an average particle diameter of 500 nm or less. The dielectric layer may include 4 to 15 wt % of a sintering aid relative to the alumina base material. The sintering aid may include magnesium oxide (MgO), manganese oxide (MnO₂), bismuth oxide (Bi₂O₃), copper oxide (CuO) and others. The internal electrode layer may contain nickel or a nickel alloy. An average particle diameter of nickel powder or nickel alloy powder may be selected considering flatness in co-sintering with the alumina base material. The internal electrode layers may include internal circuit patterns connected by vias. The internal electrode layer may include 2 to 15 wt % of a ceramic material relative to nickel. The ceramic material may contain barium titanate (BaTiO₃). The ceramic material may serve to reduce mismatching between the dielectric layer having an alumina base material and the internal electrode layer containing nickel when the two layers are co-sintered.

Next, plasticizing of the multilayer structure by heating the multilayer structure to a temperature of 500° C. to 900° C. at a first heating rate under a reducing atmosphere at a first hydrogen (H₂) concentration may proceed (Zone 1). The first heating rate may be in a range of 1.5 to 3° C./min. When the first heating rate is much higher than the range of 1.5 to 3° C./min, defects such as a split between the dielectric layer and the internal electrode layer may occur due to increased binder gas pressure inside of the multilayer structure. The plasticizing (Zone 1) may further include maintaining the temperature of 500° C. to 900° C., after heating the multilayer structure to a temperature of 500° C. to 900° C. The plasticizing is for effectively removing carbon (C) remaining in the multilayer structure, and may proceed at a temperature and under an atmosphere where the internal electrode layer of the multilayer structure is not oxidized. Gas used in the reducing atmosphere may be wet gas mixed with hydrogen and nitrogen (N₂). The first hydrogen concentration may be in a range of 0.05 to 3.0 wt % relative to nitrogen. For example, the first hydrogen concentration, according to an exemplary embodiment, may be in a range of 0.05 to 1.5%.

Next, heating the multilayer structure to a temperature of 1,250° C. to 1,400° C. at a second heating rate faster than the first heating rate under a reducing atmosphere at a second hydrogen concentration higher than the first hydrogen concentration may proceed (Zone 2). The second heating rate may be in a range of 5 to 60° C./min. Heating at the second heating rate (Zone 2) may significantly reduce mismatching between the dielectric layer containing an alumina base material and the internal electrode layer containing nickel. Further, heating at the second heating rate (Zone 2) may significantly reduce volatilization of the sintering aids which are additives contained in the dielectric layers of the multilayer structure to prevent strength of the sintered multilayer structure from being reduced. The second hydrogen concentration may be in a range of 0.05 to 3.0%. For example, the second hydrogen concentration may be in a range of 1.5 to 3.0%.

Next, sintering of the multilayer structure by maintaining the temperature of 1,250° C. to 1,400° C. may proceed (Zone 3) . The sintering (Zone 3) may be carried out for 1-4 hours. The sintering (Zone 3) may impart strength to the dielectric layer, and may inhibit the spread of alumina in the dielectric layer. Herein, a nickel aluminate (NiAl₂O₄) layer having a spinel structure may be produced between the dielectric layer containing an alumina base material and the internal electrode layer containing nickel. Since the nickel aluminate layer may reduce the flatness of the multilayer structure, the nickel aluminate layer may be prevented from being produced by controlling the reducing atmosphere to be at a third hydrogen concentration different from the first hydrogen concentration and second hydrogen concentration.

Lastly, annealing of the multilayer structure by cooling the multilayer structure to room temperature at a first cooling rate may proceed (Zone 4). The first cooling rate may be in a range of 1 to 10° C./min. The annealing (Zone 4) may inhibit thermal impact applied to the multilayer structure and impart strength to the multilayer structure.

FIG. 2 is a graph illustrating equilibrium oxygen partial pressure of metals used as an internal electrode layer of a multilayer ceramic electronic component.

Referring to FIG. 2, equilibrium oxygen partial pressure (P_{O2}) of the internal electrode layer containing nickel is higher than equilibrium oxygen partial pressure of an internal electrode layer containing tungsten (W) or molybdenum (Mo) in the existing high temperature co-sintered ceramic (HTCC) package. Further, nickel has a melting point of 1,453° C., and thus it is recognized that nickel has better sintering properties at low temperatures than tungsten and molybdenum, which have melting points of 3,695° C. and 2,617° C., respectively. Resistivities of tungsten, molybdenum and nickel are 52.8 nΩ·m, 53.4 nΩ·m, and 69.3 nΩ·m, respectively.

Generally, nickel may be sintered under a weak reducing atmosphere. Regarding an equilibrium oxygen partial pressure depending on a hydrogen concentration at 30° C. under a humid environment, nickel is stable as a metal at a hydrogen concentration of 0.05% or more, and may be sintered under a weak reducing atmosphere at a very low hydrogen concentration as compared with tungsten or molybdenum, and so it is possible to measure and control the atmosphere.

However, tungsten or molybdenum are strongly oxidative and require a very high reducing atmosphere at a hydrogen concentration of 5% or more to prevent oxidation in sintering at a high temperature of about 1,600° C. The atmosphere is not easily measured under the high reducing atmosphere, and the conditions are disadvantageous for de-binder in the inside of ceramic. Therefore, it is not easy to measure the atmosphere, and thus it may be difficult to control the spreading at the time of processing.

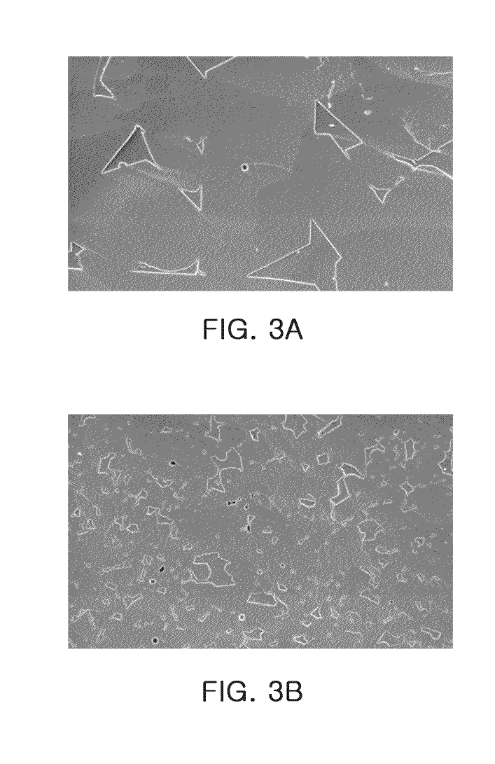

FIGS. 3A and 3B are photographs showing a part of a multilayer ceramic electronic component manufactured according to an exemplary embodiment.

Referring to FIGS. 3A and 3B, FIG. 3A represents the multilayer structure manufactured by the high temperature co-sintered ceramic process, and FIG. 3B represents a result of analyzing the multilayer structure manufactured by the medium temperature co-sintered ceramic process using a scanning electron microscope (SEM).

As seen from FIG. 3B, it is recognized that the dielectric layer of the multilayer structure manufactured by the medium temperature co-sintered ceramic process has a relatively small particle diameter, and thus the additives may be distributed over a large area. However, as seen from FIG. 3A, it is recognized that the dielectric layer of the multilayer structure manufactured by the high temperature co-sintered ceramic process has a relatively large particle diameter, and thus the additives are locally distributed.

During the co-sintering, when the hydrogen concentration was a concentration that formed a weak reducing atmosphere and the heating was at a low heating rate in a range of 1 to 2.5° C./min, a strength of 600 MPa or more was obtained in the multilayer structure manufactured by the medium temperature co-sintered ceramic process. It was observed, however, that when the hydrogen temperature was increased, the strength was lowered and the spreading was increased.

In the multilayer ceramic electronic component manufactured by the process according to an exemplary embodiment in the present disclosure, the multilayer structure having the internal electrode layers containing nickel is formed by the medium temperature co-sintered ceramic process in which a hydrogen concentration is changed depending on a sintering profile, such that the multilayer structure may have a strength of 600 MPa or more, which is similar to a multilayer structure having internal electrode layers containing tungsten or molybdenum formed by a high temperature co-sintered ceramic process. Accordingly, the method of manufacturing a multilayer ceramic electronic component being low-cost and having improved strength is provided.

While exemplary embodiments have been shown and described above, it will be apparent to those skilled in the art that modifications and variations could be made without departing from the scope of the present invention as defined by the appended claims.

What is claimed is:

1. A method of manufacturing a multilayer ceramic electronic component, the method comprising steps of:
preparing a multilayer structure in which dielectric layers containing an alumina base material and internal electrode layers containing nickel are alternately stacked;
plasticizing the multilayer structure by heating the multilayer structure to a temperature of 500° C. to 900° C. at a first heating rate under a first reducing atmosphere at a first hydrogen concentration;
sintering the multilayer structure by heating the multilayer structure to a temperature of 1,250° C. to 1,400° C. at a second heating rate greater than the first heating rate under a second reducing atmosphere at a second hydrogen concentration higher than the first hydrogen concentration and then maintaining the temperature of 1,250° C. to 1,400° C.; and
annealing the multilayer structure by cooling the multilayer structure to room temperature at a first cooling rate.

2. The method of claim 1, wherein the dielectric layer includes 4 wt % to 15 wt % of a sintering aid relative to the alumina base material.

3. The method of claim 1, wherein the alumina base material is made of fine particles having an average particle diameter of 500 nm or less.

4. The method of claim 1, wherein the internal electrode layer includes 2 wt % to 15 wt % of a ceramic material relative to the nickel.

5. The method of claim 1, wherein the first heating rate is in a range of 1.5° C./min to 3° C./min.

6. The method of claim 1, wherein the step of plasticizing further comprises maintaining the temperature of 500° C. to 900° C., after heating the multilayer structure to the temperature of 500° C. to 900° C.

7. The method of claim 1, wherein the second heating rate is in a range of 5° C./min to 60° C./min.

8. The method of claim 1, wherein the first hydrogen concentration and the second hydrogen concentration are in a range of 0.05% to 3.0%.

9. The method of claim 1, wherein the sintering is carried out for 1 hour to 4 hours.

10. The method of claim 1, further comprising controlling the reducing atmosphere to be at a third hydrogen concentration different from the first hydrogen concentration and the second hydrogen concentration during the sintering.

11. The method of claim 1, wherein the first cooling rate is in a range of 1° C./min to 10° C./min.
